(19) United States
(12) Patent Application Publication
(10) Pub. No.: US 2011/0096677 A1
(43) Pub. Date: Apr. 28, 2011

(54) APPARATUS AND METHOD FOR CONTROLLING UPLINK DEDICATED CHANNEL IN A MOBILE COMMUNICATION SYSTEM

(76) Inventor: Eun-Jung Kim, Gyeonggi-do (KR)

(21) Appl. No.: 12/673,146

(22) PCT Filed: Aug. 7, 2008
(86) PCT No.: PCT/KR2008/004600

§ 371 Date: Feb. 11, 2010

(30) Foreign Application Priority Data
Aug. 10, 2007 (KR) 10-2007-0080930

(51) Int. Cl. H04W 72/00; H04L 12/26

(52) U.S. Cl. 370/252; 370/329

(57) ABSTRACT

A method for controlling an uplink dedicated channel by a Node B in a mobile communication system. The Node B generates configuration decision information including a UE Transmission Power Headroom (UPH) included in scheduling information received from a User Equipment (UE), and determines if there is a need for a change in the uplink dedicated channel configuration information based on the configuration decision information. When there is a need for a change in the uplink dedicated channel configuration information, the Node B sends to a Radio Network Controller (RNC) the configuration decision information and a message for requesting a change in the uplink dedicated channel configuration information. The Node B receives changed uplink dedicated channel configuration information that the RNC generated based on the configuration decision information.

### BACKGROUND OF THE INVENTION

1. Field of the Invention

The present invention relates generally to an apparatus and method for controlling a dedicated channel in a wireless communication system, and in particular, to an apparatus and method for controlling an uplink dedicated channel in a wireless communication system.

2. Description of the Related Art

A mobile communication system, an example of the wireless communication systems, has been developed to provide communication services to users while guaranteeing mobility. The mobile communication system has evolved from the early system for providing voice services into an advanced system capable of providing data services as well as the voice services. Presently, the 3^{rd} Generation (3G) mobile communication system has reached its commercial phase, and the 3G mobile communication system can be classified into the 3^{rd} Generation Partnership Project 2 (3GPP2) standard, which is also called a synchronous scheme or North American scheme, and the 3GPP standard, which is also called an asynchronous scheme or European scheme.

Of the above-stated schemes, the European mobile communication system includes a Universal Mobile Telecommunication Service (UMTS) system that uses Wideband Code Division Multiple Access (WCDMA) technology based on Global System for Mobile Communications (GSM). In addition, High-Speed Downlink Packet Access (HSDPA)/High-Speed Uplink Packet Access (HSUPA) based on WCDMA can now enable wireless communication access at a rate as high as the wire broadband access rate.

HSDPA, a technology provided by remarkably increasing a transfer rate for the downlink of the existing 3GPP Release 99 (R99) WCDMA, was first introduced in 3GPP Release 5. However, HSDPA has almost no additional increase in the transfer rate for the uplink. Therefore, HSUPA was introduced in 3GPP Release 6 in order to additionally increase the rate of the uplink. HSUPA has not changed the existing channels, taking into account the backward compatibility with the existing R99 and HSDPA, and channels with a prefix ‘E-’ were newly added. That is, a new transmission channel, called an enhanced uplink dedicated channel (hereinafter referred to as an ‘Enhanced Dedicated Channel (E-DCH))’, has been introduced in addition to a Dedicated Channel (DCH) which is the existing transmission channel used in WCDMA. In other words, the term ‘HSUPA’ is a mere name used in the industrial circles to make a pair with the existing HSDPA, and its official name in the 3GPP standard is ‘E-DCH’. In the following description, E-DCH and HSDPA will be used in the same meaning. Although E-DCH will be described herein as an example of the wireless communication system, by way of example, it should be noted that the present invention is not limited to E-DCH.

A brief description will now be made of the technical characteristics of E-DCH. In order to support stabilized high-speed data transmission, E-DCH uses Adaptive Modulation and Coding (AMC), n-channel Stop And Wait Hybrid Automatic Retransmission Request (n-channel SAW HARQ), and Node B-controlled scheduling (also know as ‘Node B scheduling’), and has introduced Transmission Time Interval (TTI) of 2 ms for improvement of the system performance.

For a better understanding of the present invention, a description will now be made of the concept of Node B scheduling based on E-DCH in the WCDMA mobile communication system.

FIG. 1 is a diagram illustrating Node B scheduling based on E-DCH in a general WCDMA mobile communication system.

In HSDPA, scheduling is performed through dedicated channels. For a better understanding, the scheduling will be described with reference to HSDPA. HSDPA scheduling is a shared-concept procedure for determining to which User Equipment (UE) and how long the Node B will allocate its common resources (code and power). That is, in HSDPA, the Node B serves as a manager that has the output energy necessary for information transmission and controls the entire cell. In contrast, HSUPA has a structure in which UEs having their independent output resources transmit signals toward one Node B. That is, though the UEs individually have their output energies necessary for information transmission, the manager that controls the entire cell is the Node B. Therefore, HSUPA scheduling is not the shared-concept procedure but a dedicated-concept procedure, and for this purpose, dedicated channels are used. The detailed scheduling procedure is as follows.

In step 121, UEs 101, 102, 103 and 104 transmit E-DCH data including therein scheduling information to a Node B 110 through E-DCHs 111, 112, 113 and 114, respectively. In step 123, based on the scheduling information received from the UEs 101, 102, 103 and 104, the Node B 110 performs a scheduling operation of informing each UE whether its E-DCH data transmission is possible, or adjusting a E-DCH's data rate.

A typical example of the scheduling information can include buffer state of UE, and UE Transmission Power Headroom (UPH) of UE, and can further include required data rate, transmission-allowed timing, and channel condition information between Node B and UE. For reference, there are several scheduling algorithms available in the Node B, and a proper one of the scheduling algorithms can be used, which allocates a lower data rate to the UEs 103 and 104 located far from the Node B and allocates a higher data rate to the UEs 101 and 102 located near to the Node B, while preventing an increase in noise measured by the Node B from exceeding a predetermined target value, in order to increase performance of the entire system.

Generally, several UEs belong to one Node B. Therefore, one Node B can simultaneously receive E-DCH service requests from several UEs belonging thereto. In this case, the Node B should receive the above-stated scheduling information from the UEs. When performing scheduling on a particular UE, the Node B should take into consideration the scheduling information received from the multiple UEs. For convenience' sake, however, it will be assumed herein that the Node B performs the scheduling taking only one UE into account.

FIG. 2 is a diagram illustrating an establishment and communication procedure for E-DCH in a conventional WCDMA mobile communication system.

Referring to FIG. 2, a Node B 201 and a UE 202 establishes an E-DCH in step 203. For the E-DCH establishment, the Node B 201 and the UE 202 can exchange predetermined messages over the existing DCH channel. Since its detailed process is not directly related to the present invention, a detailed description thereof will be omitted herein. If the E-DCH establishment is made in step 203, the UE 202 generates scheduling information in step 211. The scheduling information, as described above, includes buffer state of UE, UPH of UE, etc. In step 204, the UE 202 transmits the scheduling information to the Node B 201.

Upon receipt of the scheduling information from the UE 202, the Node B 201 generates, in step 212, scheduling allocation information (scheduling grant) to notify the UE 202 of the maximum allowable transmission power, taking into account the scheduling information and the current channel condition. Thereafter, in step 205, the Node B 201 transmits the generated scheduling allocation information to the UE 202. For reference, the scheduling allocation information can be transmitted to the UE 202 over Enhanced Absolute Grant Channel (E-AGCH)/Enhanced Relative Grant Channel (E-RGCH).

The UE 202 determines a size of E-DCH to transmit and an Enhanced Transport Format Combination Indicator (E-TFCI) suitable thereto using the received scheduling allocation information in step 213, and transmits the E-DCH data and E-TFCI to the Node B 201 in step 206. Upon receipt of the E-DCH data and E-TFCI, the Node B 201 determines in step 214 occurrence/non-occurrence of an error in the E-DCH data and E-TFCI. If an error has occurred in any one of them, the Node B 201 transmits Negative Acknowledge (NACK) information, and if there is no error, the Node B 201 transmits Acknowledge (ACK) information. In addition, in step 207, the Node B 201 can reallocate resources depending on the data received from the UE 202, and retransmit even the scheduling allocation information to the UE 202. For reference, the NACK/ACK can be transmitted over Enhanced Hybrid-ARQ Indication Channel (E-HICH), and the scheduling allocation information can be transmitted through E-AGCH or E-RGCH.

As described in FIG. 2, the Node B performs scheduling on the UE using the scheduling information from the UE. As described above, HSUPA has newly added 2-ms TTIs. For reference, the conventional WCDMA system uses 10-ms TTIs. The reason for introducing the short TTIs is to minimize the time delay between the Node B and the UE during data transmission, thereby increasing the scheduling efficiency.

However, since the use of the 2-ms ITT structure, compared with the use of the 10-ms TTI structure, increases power of overhead channels and reduces the cell coverage, the 2-ms TTI structure is not always advantageous. Therefore, HSUPA can use a selected one or both of the 2-ms TTI structure and 10-ms TTI structure according to the radio condition of the UE.

Selection of the TTI structure is made according to the E-DCH configuration information (hereinafter ‘configuration information’) that the Node B has received from a Radio Network Controller (RNC). That is, based on the TTI structure included in the configuration information provided from the RNC, the Node B makes an initial E-DCH call setup to the UE, and then operates accordingly. In addition, it is defined that when there is an intention to make a change from the selected TTI structure to another ITT structure, the TTI structure cannot be changed until the RNC sends a reconfiguration request to the Node B. However, no definition of the detailed procedure for the reconfiguration request has been given in the standard.

FIG. 3 is a diagram illustrating a virtual procedure in which an RNC gets information on an established state of E-DCH in a WCDMA mobile communication system.

In step 305, an RNC 301 determines to use 2-ms TTIs or 10-ms TTIs, and transmits, to a Node B 302, E-DCH configuration information including information on the determined TTIs. In step 307, the Node B 302 and a UE 303 establish E-DCH according to the configuration information, and exchange uplink data over the established E-DCH as described in FIG. 2. Thereafter, in step 309, the RNC 301 sends a UPH request to the UE 303 via the Node B 302 to monitor the state of the UE 303 to which the E-DCH is established. In response, the UE 303 transmits in step 311 a UPH to the RNC 301 via the Node B 302.

In step 313, based on the received UPH, the RNC 301 can determine a change in E-DCH configuration when necessary according to the state of the UE 303. When determining to change the E-DCH configuration information, the RNC 301 provides, in step 315, the changed E-DCH configuration information to make a request for reconfiguration of E-DCH. Regarding the change in the configuration information, if the UPH received from the UE after determining the 2-ms TTIs during the initial E-DCH establishment indicates insufficiency of the power headroom (or surplus power), the RNC 301 changes the E-DCH configuration information so as to reconfigure the 2-ms TTIs as 10-ms TTIs.

However, in the possible case where the UE transmits information on its state (e.g., UPH) to the RNC via the Node B using a separate message for a process of changing the configuration information, the following problems may happen.

First, when the separate message is used, the message that the UE 303 transmits during exchange of the separate message between the RNC 301 and the UE 303 should be transmitted up to the RNC 301 via the Node B 302, increasing a time delay for the message and increasing a load from the Node B 302 to the RNC 301.

Second, when the UE 303 cannot transmit a message using the set TTIs due to a lack of its power, the RNC 301 may fail to receive a corresponding report. The reason why this problem occurs is because as described above, it is defined in the current HSUPA standard that only the RNC can change the configuration information such as TTI structure, or the call setup type of E-DCH. That is, if the RNC fails to properly change the configuration information such as TTI structure in response to the state of the UE as it fails to get the state information of the UE for some reasons, the UE cannot transmit data over E-DCH, suffering service interruption.

Third, if all UEs transmit their UPHs to the RNC via the Node B, a load between the Node B and the RNC may increase and thus the processing capacity available in the RNC may decrease, causing a reduction in performance of the entire system.

### SUMMARY OF THE INVENTION

An aspect of the present invention is to address at least the problems and/or disadvantages and to provide at least the advantages described below. Accordingly, an aspect of the present invention is to provide an apparatus and method capable of maintaining E-DCH service in a mobile communication system.

Another aspect of the present invention is to provide an apparatus and method by which a Node B receives scheduling information to detect a state of a UE, and provides the corresponding information to an RNC in a mobile communication system including the UE, the Node B and the RNC, all of which support E-DCH.

Further another aspect of the present invention is to provide an apparatus and method capable of efficiently changing TTI and/or call setup type according to a channel condition of a UE in a mobile communication system including the UE, the Node B and the RNC, all of which support E-DCH.

Yet another aspect of the present invention is to provide an apparatus and method capable of reducing the unnecessary load of an RNC supporting E-DCH.

Still another aspect of the present invention is to provide an apparatus and method capable of reducing a load between a Node B and an RNC, both of which support E-DCH.

Still another aspect of the present invention is to provide an apparatus and method capable of increasing transmission efficiency by increasing processing capacity of an RNC supporting E-DCH.

According to one aspect of the present invention, there is provided a method for controlling an uplink dedicated channel by a Node B in a mobile communication system. The method includes generating configuration decision information including a UE Transmission Power Headroom (UPH) included in scheduling information received from a User Equipment (UE); and determining if there is a need for a change in the uplink dedicated channel configuration information based on the configuration decision information.

Preferably, the method further includes, when there is a need for a change in the uplink dedicated channel configuration information, sending to a Radio Network Controller (RNC) the configuration decision information and a message for requesting a change in the uplink dedicated channel configuration information.

Preferably, the method further includes receiving changed uplink dedicated channel configuration information that the RNC generated based on the configuration decision information.

Preferably, the method further includes, when there is a need for a change in the uplink dedicated channel configuration information, changing the uplink dedicated channel configuration information based on the configuration decision information.

Preferably, the method further includes sending to an RNC a message indicating a change in the uplink dedicated channel configuration information.

Preferably, the method further includes, in response to the sent message, receiving from the RNC a message indicating an instruction to reconfigure the uplink dedicated channel according to the changed uplink dedicated channel configuration information.

According to another aspect of the present invention, there is provided a method for controlling an uplink dedicated channel by a Radio Network Controller (RNC) in a mobile communication system. The method includes receiving from a Node B a message indicating a need for a change in uplink dedicated channel configuration information and configuration decision information including a UE Transmission Power Headroom (UPH) of a User Equipment (UE); and changing the uplink dedicated channel configuration information based on the configuration decision information.

Preferably, the method further includes sending the changed uplink dedicated channel configuration information to the Node B.

According to further another aspect of the present invention, there is provided a method for controlling an uplink dedicated channel by a Radio Network Controller (RNC) in a mobile communication system. The method includes sending to a Node B a message indicating an instruction to reconfigure the uplink dedicated channel, upon receiving from the Node B a message indicating a change in uplink dedicated channel configuration information after the Node B changed the uplink dedicated channel configuration information based on configuration decision information including a UE Transmission Power Headroom (UPH) included in scheduling information.

According to yet another aspect of the present invention, there is provided an apparatus for controlling an uplink dedicated channel in a Radio Network Controller (RNC) for a mobile communication system. The apparatus includes a controller for generating and storing configuration decision information including a UE Transmission Power Headroom (UPH) included in scheduling information received from a User Equipment (UE), and determining if there is a need for a change in the uplink dedicated channel configuration information based on the stored configuration decision information; and a memory for storing the configuration decision information.

Preferably, when there is a need for a change in the uplink dedicated channel configuration information, the controller generates a message for requesting a change in the uplink dedicated channel configuration information, and sends the generated message and the stored configuration decision information to a Radio Network Controller (RNC) via an external interface.

Preferably, the controller receives, via the external interface, changed uplink dedicated channel configuration information that the RNC generated based on the configuration decision information in response to the sent message.

Preferably, when there is a need for a change in the uplink dedicated channel configuration information, the controller changes the uplink dedicated channel configuration information based on the configuration decision information.

Preferably, the controller sends a message indicating a change in the uplink dedicated channel configuration information, to an RNC via an external interface.

Preferably, in response to the sent message, the controller receives a message indicating an instruction to reconfigure the uplink dedicated channel from the RNC via the external interface.

According to still another aspect of the present invention, there is provided an apparatus for controlling an uplink dedicated channel in a Radio Network Controller (RNC) for a mobile communication system. The apparatus includes a controller for receiving from a Node B a message indicating a need for a change in uplink dedicated channel configuration information and configuration decision information including a UE Transmission Power Headroom (UPH) of a User Equipment (UE), storing the received configuration decision information, and changing the uplink dedicated channel configuration information based on the stored configuration decision information; and a memory for storing the received configuration decision information.

Preferably, the controller sends the changed uplink dedicated channel configuration information to the Node B.

According to still another aspect of the present invention, there is provided an apparatus for controlling an uplink dedicated channel in a Radio Network Controller (RNC) for a mobile communication system. The apparatus includes a controller for generating a message indicating an instruction to reconfigure the uplink dedicated channel and sending the generated message to a Node B, upon receiving from the Node B a message indicating a change in uplink dedicated channel configuration information after the Node B changed the uplink dedicated channel configuration information based on configuration decision information including a UE Transmission Power Headroom (UPH) included in scheduling information.

Preferably, the uplink dedicated channel configuration information includes Transmission Time Interval (TTI) length information used for data transmission/reception over the uplink dedicated channel.

Preferably, the uplink dedicated channel is an Enhanced Dedicated Channel (E-DCH).

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating Node B scheduling based on E-DCH in a general WCDMA mobile communication system;

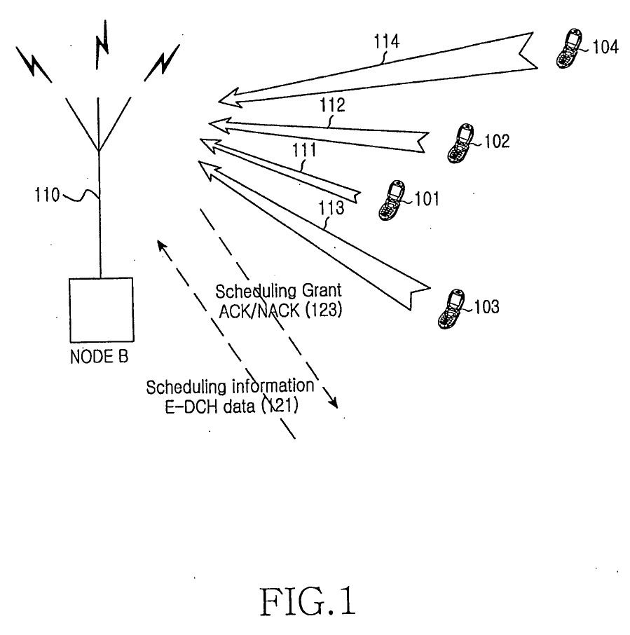

FIG. 2 is a diagram illustrating an establishment and communication procedure for E-DCH in a conventional WCDMA mobile communication system;

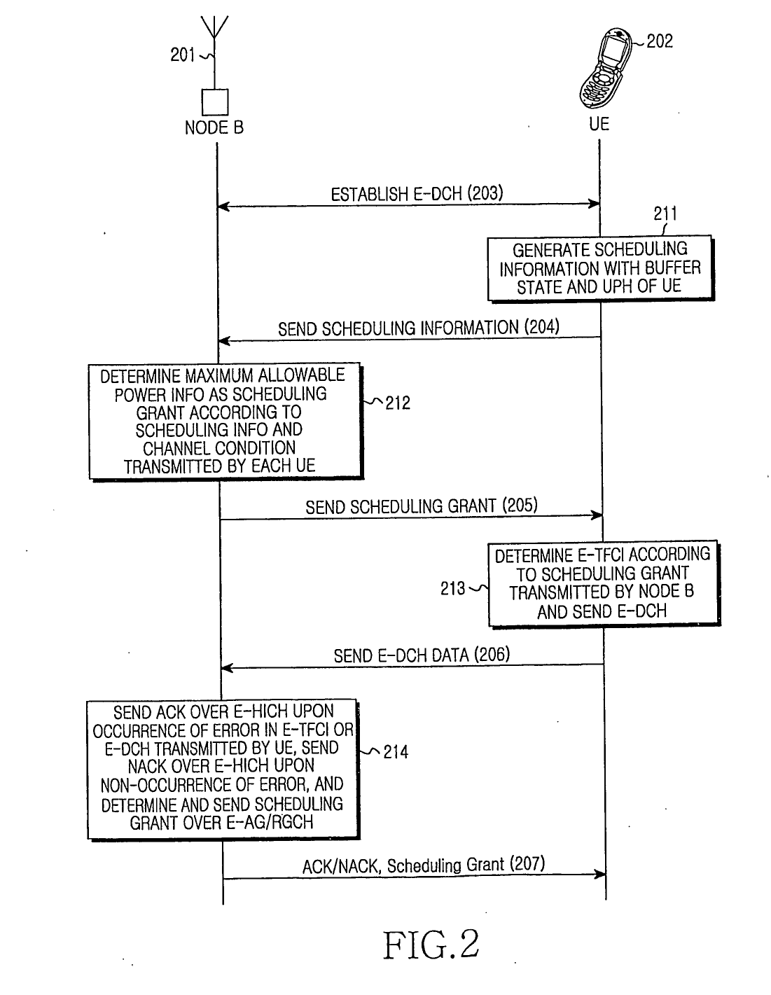

FIG. 3 is a diagram illustrating a virtual procedure in which an RNC gets information on an established state of E-DCH in a WCDMA mobile communication system;

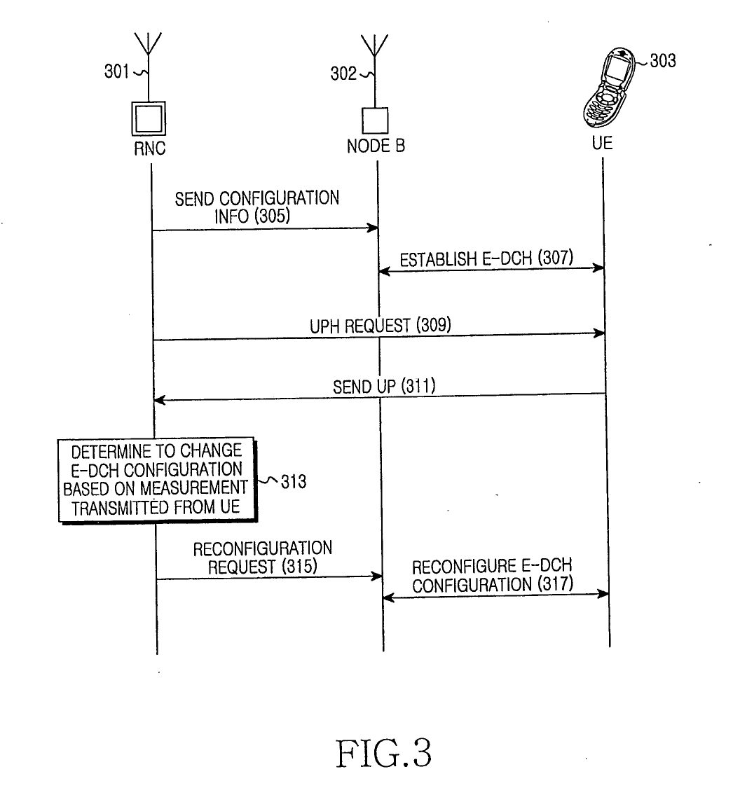

FIG. 4 is a block diagram illustrating internal structures of a Node B and an RNC, for changing configuration information according to an embodiment of the present invention;

FIG. 5 is a diagram illustrating a procedure for changing configuration information according to a first embodiment of the present invention; and

FIG. 6 is a diagram illustrating a procedure for changing configuration information according to a second embodiment of the present invention.

### DETAILED DESCRIPTION OF PREFERRED EMBODIMENTS

Preferred embodiments of the present invention will now be described in detail with reference to the annexed drawings. The matters defined in the description such as a detailed construction and elements are provided to assist in a comprehensive understanding of exemplary embodiments of the invention. Accordingly, those of ordinary skill in the art will recognize that various changes and modifications of the embodiment described herein can be made without departing from the scope and spirit of the invention. Also, descriptions of well-known functions and constructions are omitted for clarity and conciseness.

The present invention provides two possible embodiments for changing configuration information.

In a first embodiment, a Node B determines if there is a need for a change in the current configuration information, using predetermined configuration decision information. If there is a need for the change, the Node B transmits, to an RNC, the configuration decision information and a message indicating the need for a change in the configuration information, and the RNC provides information indicating how it will actually change the configuration information.

In a second embodiment, the Node B determines both the need for a change in the configuration information and how it will change the configuration information, and sends a configuration information change message to the RNC according to the determination result. The RNC sends an instruction granting the configuration information change message back to the Node B, and the Node B reconfigures the E-DCH according to the instruction.

Summarizing, in the first embodiment, the change in configuration information is made by the RNC, and in the second embodiment, this operation is performed in the Node B, and the RNC simply makes an instruction according to the operation result. Figuratively speaking, in the first embodiment, the RNC is the practical commander, and in the second embodiment, the RNC is a mere nominal commander.

In an alternative second embodiment, if the Node B has decided the details of a change in the configuration information, it can directly reconfigure an E-DCH with a UE without passing through the RNC. However, this scheme is not coincident with the HSUPA standard, since it is defined in the current HSUPA standard that only the RNC can change the configuration information, as described above. However, even this scheme can be available if the HSUPA standard is out of the question. For convenience' sake, the configuration information can be described herein as an example of TTI information. However, it is not intended to limit the configuration information to the TTI information.

A description will now be made of an apparatus to which the present invention is applied.

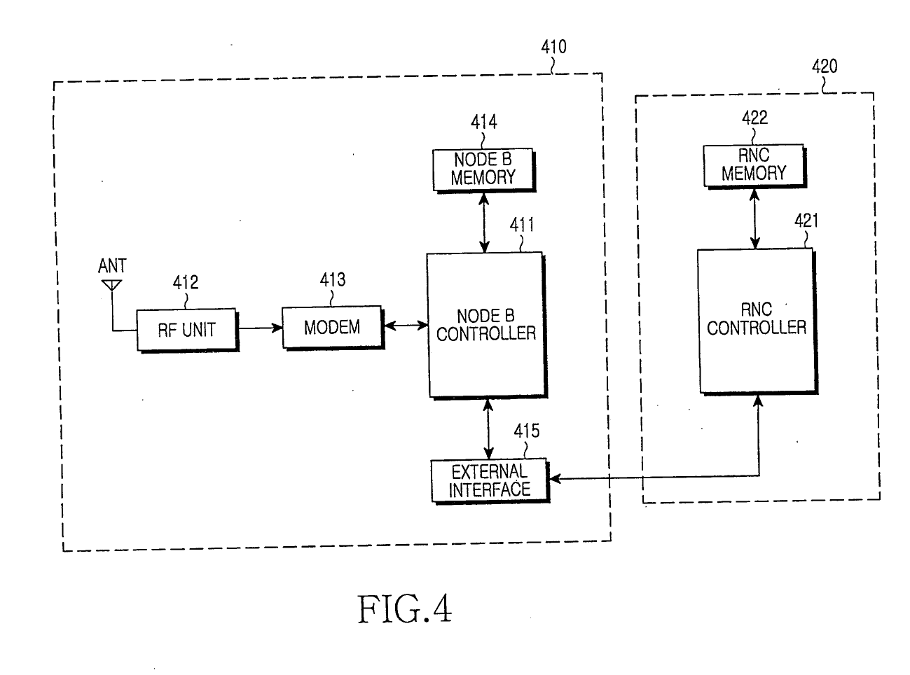

FIG. 4 is a block diagram illustrating internal structures of a Node B and an RNC, for changing configuration information according to an embodiment of the present invention. The elements unnecessary in the present invention are not shown in FIG. 4.

A Node B 410 includes an antenna ANT and a Radio Frequency (RF) unit 412. The RF unit 412 up-converts transmission data into data in a predetermined band and outputs it to the antenna ANT, and/or the RF unit 412 down-converts data received from the antenna ANT into baseband data and outputs it to a MODEM 413. The MODEM 413 demodulates and decodes the data received from the RF unit 412, and outputs it to the Node B controller 411 and/or a Node B memory 414, or to an RNC memory 422 through wireless communication. Further, the MODEM 413 codes and modulates transmission data and outputs it to the RF unit 412.

The Node B memory 414 stores the scheduling information received from a UE and the information necessary for the Node B. The ‘necessary information’ as used herein includes the configuration decision information used in the first and second embodiments of the present invention. The ‘configuration decision information’ as used herein includes a UPH detected from the scheduling information received from the UE, and a description thereof will be given below. An external interface 415 provides an interface for communication with an RNC 420.

The controller 411 generates and stores configuration decision information made from the scheduling information received from the UE, and determines if there is a need for a change in the configuration information, based on the configuration decision information.

If it is determined that there is a need for the change due to inappropriateness of the configuration, the controller 411 according to the first embodiment of the present invention transmits the configuration decision information and a message indicating the need for a change in the configuration information, to the RNC 420 through the external interface 415. For reference, the message can be transmitted along with the configuration decision information, or can be transmitted as a separate message. The message, when transmitted as a separate message, should not necessarily be transmitted simultaneously. Thereafter, upon receiving changed configuration information and a message indicating an instruction to change configuration information, from the RNC 420 via the external interface 415, the controller 411 reconfigures an E-DCH with the UE according to the changed configuration information, and performs communication over the E-DCH. In addition, the controller 411 performs the overall control of the Node B 410.

According to the second embodiment of the present invention, if it is determined that there is a need for a change in the configuration information, the controller 411 determines a change in the configuration information, and generates changed configuration information to be applied for new configuration. Thereafter, the controller 411 sends a message indicating the change in the configuration information to the RNC 420 via the external interface 415, and upon receiving a request message indicating an instruction to reconfigure the E-DCH according to the changed configuration information; from the RNC 420 in response thereto, the controller 411 reconfigures the E-DCH with the UE according to the changed configuration information. In some cases, the changed configuration information can be transmitted to the RNC 420 along with the message.

The RNC 420 includes an RNC controller 421 and an RNC memory 422. According to the first embodiment, the RNC controller 421 receives from the Node B 410 both the message indicating a need for a change in configuration information for the UE and the configuration decision information necessary for determining how the Node B 410 will change the configuration information, and stores the received message and information in the RNC memory 422. Based on the stored configuration decision information, the RNC controller 421 determines configuration information to be applied for establishment of a new E-DCH, and provides information on the changed E-DCH to the Node B 410 and the UE. In addition, the RNC controller 421 performs the overall control of the RNC 420. According to the second embodiment, the RNC controller 421 receives from the Node B 410 a message indicating the change in the configuration information, and simply sends a reconfiguration request message for E-DCH reconfiguration according thereto, without changing the E-DCH configuration information. This is because the Node B 410 has already changed the configuration information.

According to the first embodiment, the RNC memory 422 receives from the RNC controller 421 the configuration decision information and the message indicating the need for a change in the configuration information for the UE, and stores the received message and information.

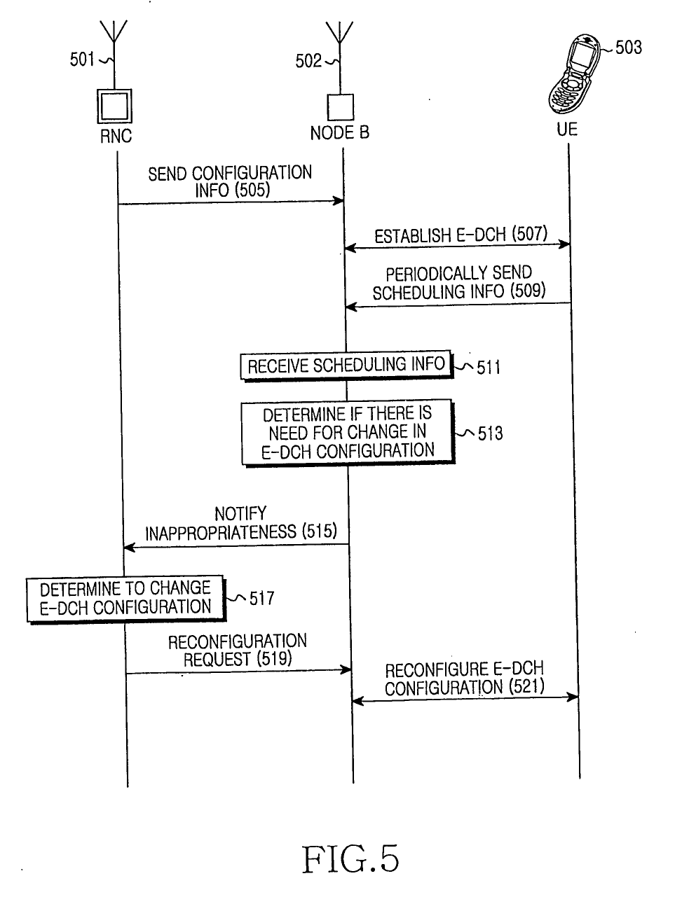

FIG. 5 is a diagram illustrating a procedure for changing configuration information according to a first embodiment of the present invention.

Steps 505 through 511 represent a process in which after the general E-DCH establishment, a Node B 502 receives scheduling information from a UE 503. In step 513, based on the received scheduling information, the Node B 502 generates configuration decision information used for determining if there is a need for a change in configuration information. The Node B 502 determines if there is a need for a change in the configuration information for the UE 503, using the configuration decision information.

It is general that the ‘configuration decision information’ as used herein is composed of a UPH itself included in the scheduling information. Therefore, the configuration decision information and the UPH can be used in the same meaning. However, the configuration decision information can include not only the UPH, but also the buffer state information included in the scheduling information and the general information (e.g., Signal-to-Interference and Noise Ratio (SINR)) capable of indicating a channel condition.

If there is a need for a change in the E-DCH configuration information for the UE, the Node B 502 sends in step 515 both the configuration decision information and a message indicating the need for a change in the current configuration information, to an RNC 501.

In step 517, the RNC 501 can change configuration information based on the configuration decision information in response to the message received in step 515. For example, if the UE 503 can hardly transmit uplink data for a reason that there is not enough power headroom for the 2-ms TTIs, the RNC 501 can determine to change the TTI length to 10 ms, or change the call setup type to R99 in which TTI is 10 ms long. In contrast, if there is enough power headroom for 10-ms TTIs and the system can sufficiently operate even with the 2-ms TTIs, given the cell capacity of the Node B 502, then the RNC 501 can determine to change the 10-ms TTIs to the 2-ms TTIs, or change the call setup type to an HDUPA call, for efficient scheduling.

After determining to change the E-DCH configuration, the RNC 501 provides in step 519 the Node B 502 with the changed E-DCH configuration information and requests the Node B 502 to reconfigure the E-DCH according thereto. Thereafter, in step 521, the Node B 502 and the UE 503 reconfigure the E-DCH according to the changed E-DCH configuration information, and then exchange uplink data over the reconfigured E-DCH.

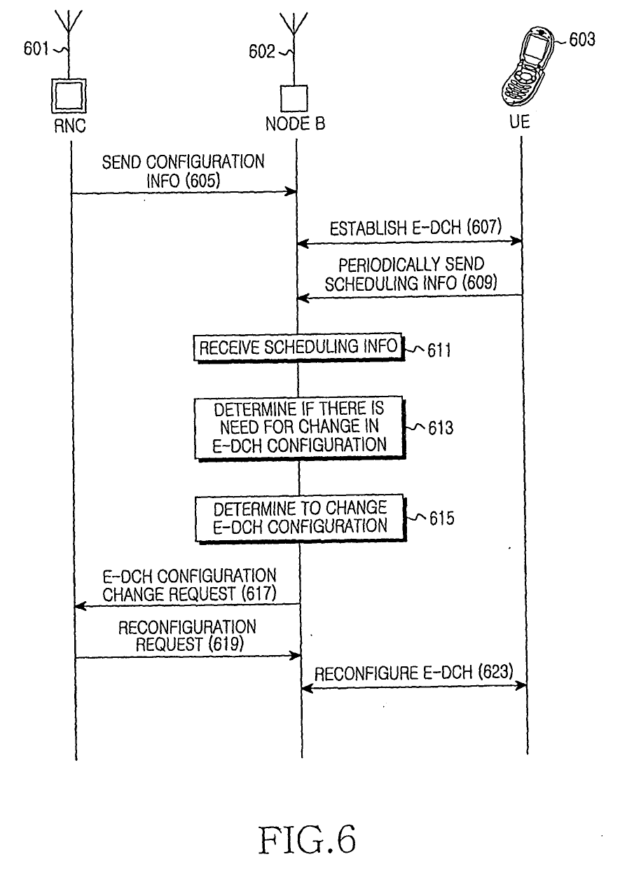

FIG. 6 is a diagram illustrating a procedure for changing configuration information according to a second embodiment of the present invention.

Steps 605 through 611 are equal in operation to steps 505 through 511 of FIG. 5 described in the first embodiment. In step 613, a Node B 602 generates configuration decision information including a UPH included in the scheduling information received from a UE 603, and based thereon, determines if there is a need for a change in the configuration information for the UE 603. If there is a need for a change in E-DCH, the Node B 602 proceeds to step 615 where it changes the configuration information. Thereafter, in step 617, the Node B 602 sends to an RNC 601 a message indicating the change in the configuration information. In this case, the Node B 602 can transmit the changed configuration information together. The RNC 601 requests in step 619 the Node B 602 to reconfigure the E-DCH according to the changed configuration information. In response to the request, the Node B 602 and the UE 603 reconfigure in step 623 the E-DCH according to the changed E-DCH configuration information, and exchange uplink data over the reconfigured the E-DCH.

As is apparent from the foregoing description, the present invention can maintain the E-DCH service in the mobile communication system, and can reduce the unnecessary load of the RNC supporting E-DCH. In addition, the present invention can reduce the load between the Node B and the RNC, both of which support E-DCH, and can increase the transmission efficiency by increasing the processing capacity of the RNC supporting E-DCH.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for controlling an uplink dedicated channel by a Node B in a mobile communication system, the method comprising:
generating configuration decision information including a UE Transmission Power Headroom (UPH) included in scheduling information received from a User Equipment (UE); and
determining if there is a need for a change in the uplink dedicated channel configuration information based on the configuration decision information.

2. The method of claim 1, further comprising:
when there is a need for a change in the uplink dedicated channel configuration information, sending to a Radio Network Controller (RNC) the configuration decision information and a message for requesting a change in the uplink dedicated channel configuration information.

3. The method of claim 2, further comprising:
receiving changed uplink dedicated channel configuration information that the RNC generated based on the configuration decision information.

4. The method of claim 1, further comprising:
when there is a need for a change in the uplink dedicated channel configuration information, changing the uplink dedicated channel configuration information based on the configuration decision information.

5. The method of claim 4, further comprising:
sending to an RNC a message indicating a change in the uplink dedicated channel configuration information.

6. The method of claim 5, further comprising:
in response to the sent message, receiving from the RNC a message indicating an instruction to reconfigure the uplink dedicated channel according to the changed uplink dedicated channel configuration information.

7. The method of claim 1, wherein the uplink dedicated channel configuration information includes Transmission Time Interval (TTI) length information used for data transmission/reception over the uplink dedicated channel.

8. The method of claim 1, wherein the uplink dedicated channel is an Enhanced Dedicated Channel (E-DCH).

9. A method for controlling an uplink dedicated channel by a Radio Network Controller (RNC) in a mobile communication system, the method comprising:
receiving from a Node B a message indicating a need for a change in uplink dedicated channel configuration information and configuration decision information including a UE Transmission Power Headroom (UPH) of a User Equipment (UE); and
changing the uplink dedicated channel configuration information based on the configuration decision information.

10. The method of claim 9, further comprising:
sending the changed uplink dedicated channel configuration information to the Node B.

11. The method of claim 9, wherein the uplink dedicated channel configuration information includes Transmission Time Interval (TTI) length information used for data transmission/reception over the uplink dedicated channel.

12. The method of claim 9, wherein the uplink dedicated channel is an Enhanced Dedicated Channel (E-DCH).

13. A method for controlling an uplink dedicated channel by a Radio Network Controller (RNC) in a mobile communication system, the method comprising:
sending to a Node B a message indicating an instruction to reconfigure the uplink dedicated channel, upon receiving from the Node B a message indicating a change in uplink dedicated channel configuration information after the Node B changed the uplink dedicated channel configuration information based on configuration decision information including a UE Transmission Power Headroom (UPH) included in scheduling information.

14. The method of claim 13, wherein the uplink dedicated channel configuration information includes Transmission Time Interval (TTI) length information used for data transmission/reception over the uplink dedicated channel.

15. The method of claim 13, wherein the uplink dedicated channel is an Enhanced Dedicated Channel (E-DCH).

16. An apparatus for controlling an uplink dedicated channel in a Radio Network Controller (RNC) for a mobile communication system, the apparatus comprising:
a controller for generating and storing configuration decision information including a UE Transmission Power Headroom (UPH) included in scheduling information received from a User Equipment (UE), and determining if there is a need for a change in the uplink dedicated channel configuration information based on the stored configuration decision information; and
a memory for storing the configuration decision information.

17. The apparatus of claim 16, wherein when there is a need for a change in the uplink dedicated channel configuration information, the controller generates a message for requesting a change in the uplink dedicated channel configuration information, and sends the generated message and the stored configuration decision information to a Radio Network Controller (RNC) via an external interface.

18. The apparatus of claim 17, wherein the controller receives, via the external interface, changed uplink dedicated channel configuration information that the RNC generated based on the configuration decision information in response to the sent message.

19. The apparatus of claim 16, wherein when there is a need for a change in the uplink dedicated channel configuration information, the controller changes the uplink dedicated channel configuration information based on the configuration decision information.

20. The apparatus of claim 19, wherein the controller sends a message indicating a change in the uplink dedicated channel configuration information, to an RNC via an external interface.

21. The apparatus of claim 20, wherein in response to the sent message, the controller receives a message indicating an instruction to reconfigure the uplink dedicated channel from the RNC via the external interface.

22. The apparatus of claim 16, wherein the uplink dedicated channel configuration information includes Transmission Time Interval (TTI) length information used for data transmission/reception over the uplink dedicated channel.

23. The apparatus of claim 16, wherein the uplink dedicated channel is an Enhanced Dedicated Channel (E-DCH).

24. An apparatus for controlling an uplink dedicated channel in a Radio Network Controller (RNC) for a mobile communication system, the apparatus comprising:
a controller for receiving from a Node B a message indicating a need for a change in uplink dedicated channel configuration information and configuration decision information including a UE Transmission Power Headroom (UPH) of a User Equipment (UE), storing the received configuration decision information, and changing the uplink dedicated channel configuration information based on the stored configuration decision information; and
a memory for storing the received configuration decision information.

25. The apparatus of claim 24, wherein the controller sends the changed uplink dedicated channel configuration information to the Node B.

26. The apparatus of claim 24, wherein the uplink dedicated channel configuration information includes Transmission Time Interval (TTI) length information used for data transmission/reception over the uplink dedicated channel.

27. The apparatus of claim 23, wherein the uplink dedicated channel is an Enhanced Dedicated Channel (E-DCH).

28. An apparatus for controlling an uplink dedicated channel in a Radio Network Controller (RNC) for a mobile communication system, the apparatus comprising:
a controller for generating a message indicating an instruction to reconfigure the uplink dedicated channel and sending the generated message to a Node B, upon receiving from the Node B a message indicating a change in uplink dedicated channel configuration information after the Node B changed the uplink dedicated channel configuration information based on configuration decision information including a UE Transmission. Power Headroom (UPH) included in scheduling information.

29. The apparatus of claim 28, wherein the uplink dedicated channel configuration information includes Transmission Time Interval (TTI) length information used for data transmission/reception over the uplink dedicated channel.

30. The apparatus of claim 28, wherein the uplink dedicated channel is an Enhanced Dedicated Channel (E-DCH).
